(19) United States
(12) Patent Application Publication
(10) Pub. No.: US 2016/0335707 A1
(43) Pub. Date: Nov. 17, 2016

(54) MERCHANT ENGAGEMENT VIA PERSONAL VIRTUAL CARTS

(71) Applicant: ARCADIER PTE LTD, Singapore (SG)

(72) Inventors: DINUKE PRASANNA MATTHEW RANASINGHE, Singapore (SG); PAUL JOHN CASCUN, New South Wales (AU); KENNETH LOW KWOK SHION, Singapore (SG)

(21) Appl. No.: 15/111,350

(22) PCT Filed: Jan. 14, 2014
(86) PCT No.: PCT/SG2014/000008

§ 371 Date: Jul. 13, 2016

(51) Int. Cl. G06Q 30/06; G06Q 20/40; G06Q 30/02

(52) U.S. Cl. CPC G06Q 30/0633; G06Q 30/0207; G06Q 30/0277; G06Q 20/40

(57) ABSTRACT

This invention relates generally to electronic commerce. More specifically, this invention relates to the shopping process and experience via multi-merchant, multi-channel and multi-media personal virtual carts, and an innovative system and method allowing merchants to engage repeatedly shoppers, once the merchants have initially engaged with the shoppers through the personal virtual carts, to encourage sales and increase sales volume.

### FIELD OF INVENTION

This invention relates generally to electronic commerce. More specifically, this invention relates to the shopping process and experience via multi-merchant, multi-channel and multi-media personal virtual carts, and an innovative system and method allowing merchants to engage repeatedly shoppers, once the merchants have initially engaged with the shoppers through the personal virtual cart.

### BACKGROUND

In this age of technological advancement, commercial transactions can take place via various avenues, be it digitally (online environment) or physically (offline environment), or a mixture of both.

For shoppers, this provides greater choices and convenience. A shopper may choose to shop at a physical store with friends and family, or shop online from the comfort of the shopper's own home and at any time of convenience. However, one problem faced by many shoppers currently is their inability to “browse” freely and hold on to shopping items whilst considering or comparing the items across multiple merchants, and also whilst shopping in both the digital and physical environment.

Most stores, physical or online, offer only items of a single merchant for sale. Although departmental stores and online stores such as “Amazon.com” provide shoppers with more choices and convenience by offering products from a variety of merchants for sale through their single platform, it is usually limited to the items or merchants selected by the owners of the store (in this case, selected by Amazon). In recent years, many merchants provide shoppers with an option of shopping at both their physical store, or via their online store. However, a shopper is only able to shop at the physical store or the online store at any one time, but not at both at the same time. Moreover, the shoppers are restricted to either items of a single merchant, or the items of selected merchants.

Further, online stores usually provide shoppers with a “virtual shopping cart” function, which enables shoppers to keep track of their selected items, and of the applicable price of the items, the related shipping costs, tax and applicable discounts, if any. In Patent Application No. PCT/US2012/058745, such a typical virtual shopping cart is disclosed. Some online merchants even allow the shoppers to save the selected items added into the shopping cart within the online store, so that shoppers may purchase the selected items at a later time and date when they re-visit the website. However, this is typically restricted to a digital (online) environment. A shopper who wishes to browse in an online store and a physical store at the same time must manage numerous shopping applications in their advanced mobile communication (“smart”) devices while shopping in both digital and physical environments. For example, a shopper has to use the virtual shopping cart of a particular online store to keep track of items they are considering for purchase from that particular online store, and non-merchant proprietary systems to keep track of the items they are considering for purchase at a particular physical store. Management of all these applications require greater efforts by the shopper, which in most cases does not occur.

Moreover, if an online store does not provide shoppers with the function of saving selected items in their virtual shopping cart, or a shopper leaves the store for any reason without first making any purchases, the shopper would then have to begin the whole shopping process (e.g. of browsing and selection of items) again, should he or she decide to re-visit the store to try to purchase the selected items.

In recent years, many systems have been invented and continuously developed to provide shoppers with a more unified shopping experience. For instance, Patent Application No. PCT/US2007/018292 discloses a universal virtual shopping cart which enables shopping across multiple merchants, through multiple media, in both digital and physical environments. In this invention, the universal shopping cart may be linked via a computer network to clearing houses, co-operative associations or other services that have the ability to deliver a product faster, cheaper, in better quality and/or to a better location. The shopping system described in Patent Application No. US20130211953 A1 is also invented to enable shopping across multiple merchants, through multiple media, in both digital and physical environments. This invention is aimed at enabling shoppers to share information of items of interests in a shared virtual shopping cart.

On the other hand, for the merchants, the rise of online shopping results in increasing competition that spans across both the digital and physical world.

As the use of smart devices becomes more prevalent, the practice of “Show Rooming” also emerged. Show Rooming is the practice of shoppers browsing in physical stores, and then searching online for lower prices and better deals. For merchants operating physical stores, this practice results in lost sales, and also leaves a negative impact on the revenues of merchants operating physical stores.

With increasing competition, merchants are constantly looking for ways to engage and stay engaged with shoppers, and further entice them to make purchases.

To target or re-target shoppers, most merchants utilise generic mechanisms to entice shoppers back into their “store” and purchase from them. The offer received by a shopper or the enticement to return to a merchant's store, is indistinguishable from the offers or enticement sent by the merchant to other shoppers. There is currently no offer unique to the shopper, suited to the shopper's individual needs. There are only generic offers which are similar to the offers that the shopper would have received from other merchants as well. For example, coupons for “10% discount”, “Buy 1, Free 1” promotions, and so forth are generic offers. At most, some merchants may create somewhat customised offers based on behavioural history of the shopper. For example, a shopper always buys from the merchant's online store during Valentine's Day, or they only buy wine from a particular grocery store, and offers may be “customised” to take advantage of such patterns or preferences. These offers may have some relevance, but these offers are only indicative of a general preference shown, and do not amount to a highly “personalised” offer. In this circumstance, the offer is not tied personally to a merchant's inventory with the Shopper's intent to purchase or to do with something browsed in the store, but rather, the offers are based on shopping behaviour or purchase preference based on a previous purchase.

Unfortunately, most merchants still do not have the capability to create specific, personalised or customised offers to engage and re-target shoppers who have previously engaged with their “store”.

Inventions which are aimed at enabling multi-merchant and/or multi-channel and/or multi-media shopping currently do not enable merchants to engage and stay engaged with shoppers. As can be seen in Patent Application No. PCT/US2012/028385, the invention only enables storage of information on the server and not interaction with the merchants' servers or databases. The invention in PCT/US2007/072269 facilitates direct relationships between shoppers and an agent, and not the merchants themselves.

The present invention is directed at overcoming or at least reducing some or more of the problems set forth above by not only enabling shoppers to shop across multiple merchants, on multiple media, in both digital and physical environments at the same time, but also to enable merchants to target and re-target these shoppers once they have initially engaged with them through a store or media interface, directly through a personal virtual cart.

### SUMMARY OF THE INVENTION

The present invention relates to computer-implemented methods, systems and computer program products which enable shopping across multiple merchants, multi-channel and multi-media as well as targeting and re-targeting of shoppers by merchants upon initial engagement using personal virtual carts. A shopper may shop across multi-merchants, through multi-media and in both digital or physical environments at the same time using a personal virtual cart while a merchant or merchant proxy may target and re-target shoppers once they have initially engaged with the merchant or merchant proxy via a personal virtual cart, by making specific, personalised or customised offers, for the purpose of generating greater sales volume.

In one exemplary embodiment of the present invention, a system comprises a plurality of personal virtual carts associated with shopping devices, wherein the devices are connected to a proprietary platform by a network. The personal virtual carts enable shoppers to browse and purchase from multiple merchants, through multiple media, in both digital and physical environments, and merchants or merchant proxies to make specific, personalised or customised offers to shoppers to target and re-target them once they have initially engaged with the merchants or merchant proxies, for the purpose of generating greater sales volume.

In a second exemplary embodiment of the present invention, a computer-implemented method comprises establishing personal virtual carts associated with shopping devices wherein the devices are connected to a proprietary platform through a network, enabling shopping across multiple merchants, through multiple media, in both digital and physical environments as well as targeting and re-targeting of shoppers with specific, personalised or customised offers by merchants, upon initial engagement, for the purpose of generating greater sales volume.

In a third exemplary embodiment of the present invention, a computer program product comprises a computer readable storage medium having computer readable program code embodied therewith. The computer readable program code comprises computer readable program code configured to establish a plurality of personal virtual carts associated with shopping devices, wherein the devices are connected to a proprietary platform by a network. The personal virtual carts enable shoppers to browse and purchase from multiple merchants, through multiple media, in both digital and physical environments, and merchants or merchant proxies to make specific, personalised or customised offers to shoppers to target and re-target them once they have initially engaged with the merchants or merchant proxies, for the purpose of generating greater sales volume.

The details of the present invention, both as to its structure and operation, are described below in reference to the accompanying drawings. This summary is intended to identify the key features of the present invention, but it is not intended to be used to limit the scope of the present invention.

### DETAILED DESCRIPTION

The present invention relates generally to electronic commerce. More specifically, the present invention is directed to systems, methods and computer program products for shopping across multiple merchants, multi-channel and multi-media, as well as targeting and re-targeting of shoppers by merchants upon initial engagement using personal virtual carts.

The personal virtual cart is a single proprietary application that may be ubiquitously and simultaneously used across numerous merchants in both digital (online) and physical (offline) environments, unifying numerous vectors of entry.

The personal virtual shopping cart may be presented within an application or through a web browser in a shopping device, which is connected to and interfaces with a proprietary platform through a network. The shopping device may be any smart device, which are devices that can operate interactively and autonomously and which may connect to and interface with the proprietary platform. For example, smart phones, tablets, computers, smart television, and so forth

The proprietary platform to which the personal virtual cart is connected consists of a three-tiered architecture consisting of client-business logic server databases that are protected by a firewall for security. The business logic servers are predominantly web servers coded with business logic as well as other business logic encoding nodes which include hardware connectivity to external systems, execution devices to process data and abstraction tools to parse the information being handed. The database servers are any node optimised for handling volume data and performing logic data extraction queries. The three tiers of the proprietary platform can be composed of heterogeneous elements both within and across the three tiers. As such, a population of dissimilar shopping devices can communicate with a data centre of dissimilar servers that store their data on dissimilar database servers. What is common is the communication that occurs between the tiers. For example, any of the shoppers' devices can communicate with the server via TCP/IP and other internet based protocols, some of which are proprietary for the signalling required for the purpose of application activity. Further, the communication between the logic servers and the database servers is performed predominantly in SQL and other semaphore based communication styles. Both shopper/server and server/database communication is bi-directional. When shoppers and merchants interact with the proprietary platform via the shoppers' devices, the server adheres to the business processes and thereafter retrieves and checks against information from the database server. The system uses, but are not restricted to Android, iOS, QNX, Unix variants and Windows operating systems, Microsoft SQL, android native, iOS native databases and Android, iOS, windows and unix file systems.

Shoppers' devices may be connected to the platform through any computer or data network which allows computing devices to communicate via data connections. These networks could be cable networks, wireless networks or any other signalling media.

The personal virtual cart is used by shoppers to keep track of selected shopping items, to retrieve and access relevant information of the selected shopping items such as pricing, product descriptions, store locations, marketing information and so forth as well as to purchase the selected shopping items. A shopper may enter shopping items from any participating merchant who are connected to the proprietary platform. Participating merchants may connect to the proprietary platform via the merchants' existing proprietary systems or other proprietary network systems which the merchants subscribed to in order to manage and sell their items. Alternatively, a participating merchant may manually upload their information or their inventory into the proprietary platform, for shoppers' access. This alleviates the need for shoppers to manage numerous applications while shopping.

A shopper may enter shopping items of participating merchants found digitally or physically, including items in online or physical stores as well as items as set out in the participating merchants' physical printed marketing materials such as billboards, magazines, newspapers and so forth or digital marketing media such as web advertising, electronic direct mail and so forth.

Selected shopping items from multiple merchants, in both digital and physical environments may be entered into a personal virtual cart through various and multiple vectors of entry, including but not limited to barcodes, Quick Response (QR) codes, image scan, Near Field Communication (NFC), Bluetooth (Low Energy) (BLE), Digital (Web and mobile) click, sound waves and white noise, biometrics, in-app selection and so forth. For example, a barcode is an optical machine-readable representation of data relating to the shopping item to which it is linked, on both digital and physical interfaces. The barcode enables an information transfer for the item tagged with the barcode. For items on which barcodes are tagged with a barcode, a shopper may use a shopping device in which the personal virtual cart application is operated to scan the barcode on the item to download information of the item and thereby “enter” the item into the personal virtual cart.

Upon the entry of an item into a personal virtual cart, an actual order of the item of interest in the shopper's personal virtual cart is created. At this time, the shopper develops a direct relationship with the merchant of the item(s) and may directly engage the merchant to purchase the items in the order (directly from the merchant) immediately or at a later time and date, or interact with the merchant.

Upon the entry of an item into a shopper's personal virtual cart, the merchant of the selected item or merchant proxy may also directly contact and engage the shopper by creating specific, personalised or customised offers to the shopper pertaining directly or indirectly to items in the shopper's personal virtual cart. The specific, personalised or customised offers may include price changes, discount coupons, free delivery services, complementary items, and other incentives that may entice a shopper to make purchases.

Should the shopper decide to proceed to purchase the items in the order, the shopper can then send instructions to the payment processor for authorisation, through the platform. Payment authorisation can take various forms and will depend on the payment processor's proprietary authorisation flows, as well as respective card scheme, bank and regulatory requirements or any other existing and relevant financial services legislation. Parts of the authorisation process flow may reside on the proprietary platform, as required by the payment processor to enable the authorisation of the payment.

Even if a shopper leaves a digital or physical merchant store, it is still possible for them to purchase later because the item(s) placed in a personal virtual cart may be purchased at any later or more convenient time as the shopper chooses. Whilst the shopper considers the item(s) in the shopper's personal virtual cart for purchase, the a merchant or merchant proxy merchant have the opportunity to re-target and re-engage the shopper to convince the shopper to purchase the item(s) regardless of the channel the shopper initially engaged with the merchant.

Referring to FIG. 1, Shopper 101 discovers item(s) of interest whilst shopping online and/or at a physical store. Shopper 101 then enters the item(s) into the personal virtual cart of Shopper 101 using a device which is connected to and interfaces with a proprietary Platform 103 through an application within the or a web browser via a network.

Platform 103 provides merchants or merchant proxies with the capabilities to load their inventories by form of connections to the merchants' pre-existing proprietary systems or a proprietary network system(s) which the merchants subscribed to in order to manage and sell their items. In the case of the later, Platform 103 can, by batch or in real-time, retrieve required information from the proprietary systems or network systems when prompted.

Platform 103 provides shoppers with the capabilities to search and retrieve information of selected item(s) such as the merchant details, pricing, availability and so forth as well as to create, manage and track orders.

Upon the entry of the selected items into the personal virtual cart of Shopper 101, Shopper 101 would then be able to retrieve all relevant information of the item(s). At the same time, an order of the selected item(s) is created in the personal virtual cart of Shopper 101.

Once an order is created on Platform 103 and Shopper 101 decides to proceed to make the purchase, instructions will then be sent to the Payment Processor 104 for authorisation. Payment authorisation can take various forms and will depend on the Payment Processor's proprietary authorisation flows, as well as card scheme, bank and regulatory requirements or any other existing and relevant financial services legislation. Parts of the authorisation flow of Payment Processor 104 may reside on Platform 103 as required by Payment Processor 104 to enable the authorisation of the payment.

When an order is placed, the order will either be placed on Platform 103 for the merchant who may then assess the placed order on the merchant's device 106 via an interface to Platform 103 or instructions may be sent directly to the merchant's own proprietary system or network of systems which the merchant subscribes to. The merchant may then proceed to fulfil the order and complete the purchase.

In one aspect of the present invention and referring to FIG. 2, a shopper may shop across multiple unrelated and distinct merchants, through numerous market channels, for instance digitally, in an online store, an online Marketplace or an electronic commerce enabled social media platform. A shopper may even be shopping through physical printed marketing materials such as billboards, magazines, newspapers and so forth or digital marketing media such as web advertising, electronic direct mail, emission and so forth. A shopper could also be shopping at a physical (offline) retail store 201.

When the shopper discovers items of interest, the shopper may then enter the items into the personal virtual cart through numerous vectors of entry, for so long as the technology at the time enables the capability of the present invention 202.

The selected items are then added into the personal virtual cart of the shopper via Network 203 and Platform 204, where items are identified, checked for availability and an order which comprises of the selected items is created and reflected in the personal virtual cart and tracked and managed via Platform 204.

In another aspect of the present invention, a shopper may shop via multiple media, using various vectors of entry simultaneously or at different times. Referring to FIG. 3, while shopping online 301, Shopper A discovers items A and B and enters items A and B into the personal virtual cart of Shopper A by clicking on item A and scanning the QR codes of item B. While shopping at a physical store 302, Shopper A discovers items C, D and E and enters items C, D and E into the personal virtual cart of Shopper A using High Frequency, NFC and BLE. While shopping via a mobile application 303, Shopper A discovers item F and enters item F into the personal virtual cart of Shopper A by tapping on item F.

Upon entering all the selected items A, B, C, D, E and F using various vectors of entry into the personal virtual cart of Shopper A via Platform 304 and Network 305, an order(s) comprising of items A, B, C, D, E and F is created in the personal virtual cart of Shopper A.

In another aspect of the present invention and referring to FIG. 4, the orders created in a personal virtual cart may be assessed and presented within an application in a shopper's device, or through a web browser interface on the shopper's device.

In another aspect of the present invention and referring to FIG. 5, Shopper A discovers item(s) of interest whilst shopping online and/or at a physical store or on digital or print media. Shopper A then enters the selected item(s) into the personal virtual cart of Shopper A and thereby creates an order comprising the selected item(s) 502. However, Shopper A does not proceed to purchase the selected item(s) immediately but wishes to first consider before purchasing or look for other comparable items. Once item(s) are entered into a personal virtual cart, the items/orders remain in the personal virtual cart for as long as Shopper A does not proceed to purchase the items or delete the items/order from the personal virtual cart 503.

Upon entering of the selected item(s) into the personal virtual cart of Shopper A and the creation of an order therein comprising of the selected item(s), the merchant(s) of the selected item(s) would then be notified of the same and will be able to view the order on the merchant's platform or a central platform to which the merchant has access 504. The merchant(s) of the selected item(s), or a merchant proxy, can then directly contact and engage the shopper and/or make specific or personalised or customised offer(s) pertaining to the specific item(s) or the entire order created by the shopper in the shopper's personal virtual cart 505.

The offer personalised or customised for Shopper A would be reflected in the personal virtual cart of Shopper A along with updated details of the item(s) in the order, for Shopper A's review 506.

Upon reviewing the merchant's or merchant proxy's offers 507, Shopper A may then ignore the offer and leave some or all of the items in the order in the personal virtual cart for later 509 or delete some or all of the items in the order in the personal virtual cart 510 or take up the offer and proceed to check out and purchase some or all of the items in the order according to the offer 511.

In another aspect of the present invention and referring to FIG. 6, Shopper A discovers Items 1, 2, 3 and 4 from Merchant B's “store” whilst shopping and enters these items into Shopper A's personal virtual cart 601. Upon the entry of Items 1, 2, 3 and 4 into Shopper A's personal virtual cart, Merchant B would then be notified and be able to view the items from their store that are added into Shopper A's personal virtual cart 602. Merchant B can then make personalised offers to Shopper A on each or all of the items in the order in Shopper A's personal virtual cart 603. Once Merchant B or the merchant proxy creates the offers, Shopper A would then be able to view offers in the personal virtual cart of Shopper A 604.

In another aspect of the present invention and referring to FIG. 7, upon the entry of items from multiple Merchants B, C and D are entered into the Shopper A's personal virtual cart at the same/different times 701, Merchants B, C and D will notified 702. Merchants B, C and D, or a merchant proxy may then simultaneously and separately make offers or provide Shopper A with enticement to purchase items/orders from each of them respectively 703. These offers or enticements would then be reflected in Shopper A's personal virtual cart alongside 1 another, for Shopper A's review 704. Upon, reviewing the offers or enticement in relation to each item/order, Shopper A may then proceed to purchase or ignore or delete some or all of the items of each or all of the Merchants B, C, D or the merchant proxy 705.

In another aspect of the present invention and referring to FIG. 8, upon the entry of item(s) into a shopper's personal virtual cart, the merchant to which the item(s) relate would be notified. The merchant would then be able to access the merchant's platform or central platforms to which the merchant subscribe 801 and view all the shoppers who entered item(s) from the merchant's “store” into their personal virtual cart 802. These shoppers can be already known or still unknown to the merchant. The only identifying factor is that an item which the merchant is selling has been added to the personal virtual carts of these shoppers.

At this stage, the merchant or a merchant proxy can create a blanket offer to all the shoppers who entered the merchant's item(s) into their personal virtual cart 803. Alternatively, the merchant or merchant proxy can specifically select a shopper and create personalised or customised offers to individual shopper 804. In this case, even if other shoppers have the same item(s) in their personal virtual carts, they may not receive the same offer.

A merchant or merchant proxy also has the capability to pre-set automatic offers to all shoppers who enters specific item(s) into their personal virtual carts 805. In such cases, the entry of certain item(s) into shoppers' personal virtual carts would trigger the merchant's platform 806 which would then automatically create offers to the Shoppers who entered those items into their personal virtual cart 807.

Once the merchant or merchant proxy makes an offer, manually or automatically, the shopper(s) offered would be able to view the offer in the shopper(s)'s personal virtual cart 808. The shoppers can thereafter ignore the offer and leave the item(s)/order(s) in the shoppers' personal virtual cart 810 or proceed to checkout and purchase the item(s) based on the new offered terms 811 or delete the item(s)/order(s) in the personal virtual cart 812.

In another aspect of the present invention and referring to FIG. 9, a merchant or merchant proxy may access the Platform 901 and view all the shoppers using the Platform and their orders/purchases regardless of whether the same shoppers have previously purchased from the merchant. The merchant or merchant proxy in this case views Shopper B's details, which may include all part transactions and non-transaction behaviour, contact details and other details. Upon viewing Shopper B's Order details 902, the merchant or merchant proxy notices that Shopper B had previously purchased sushi or has indicated in his personal profile that he likes sushi or Japanese food in general 903. The merchant in this case happened to be a seller of Japanese cuisine and through the platform creates an order with a special offer specifically for Shopper B 904. A merchant proxy may act on the behalf of a merchant, who in this case happened to be a seller of Japanese cuisine, and through the platform creates an order with a special offer specifically for Shopper B 904. The merchant or merchant proxy then sends the order to the personal virtual cart of Shopper B, together with a special offer 905. At this stage, Shopper B may or may not have previously interacted with the merchant. When Shopper B views his personal virtual cart, Shopper B will see that an order has been created and entered into his personal virtual cart by the merchant or merchant proxy 907. Shopper B can thereafter choose to ignore the offer and leaves the order in his personal virtual cart 909 or proceed to checkout and make purchase the item(s) in the order according to the offer 910 or delete the order from his personal virtual cart 911.

In another aspect of the present invention and referring FIG. 10, Merchant A or merchant proxy accesses the Platform (in this case, a browser or application based merchant management portal) to unilaterally create an order specifically for Shopper B and adds the order into the personal virtual cart of Shopper B. Shopper B can then decide whether to make the purchase of the items in the order or ignore the order created by Merchant A or merchant proxy, or delete the order from the personal virtual cart.

### BRIEF DESCRIPTION OF THE DRAWINGS

FIG. 1 is a representation of an aspect of the present invention where a shopper, using a smart device or other interfaces the platform supports, to shop or make a purchase.

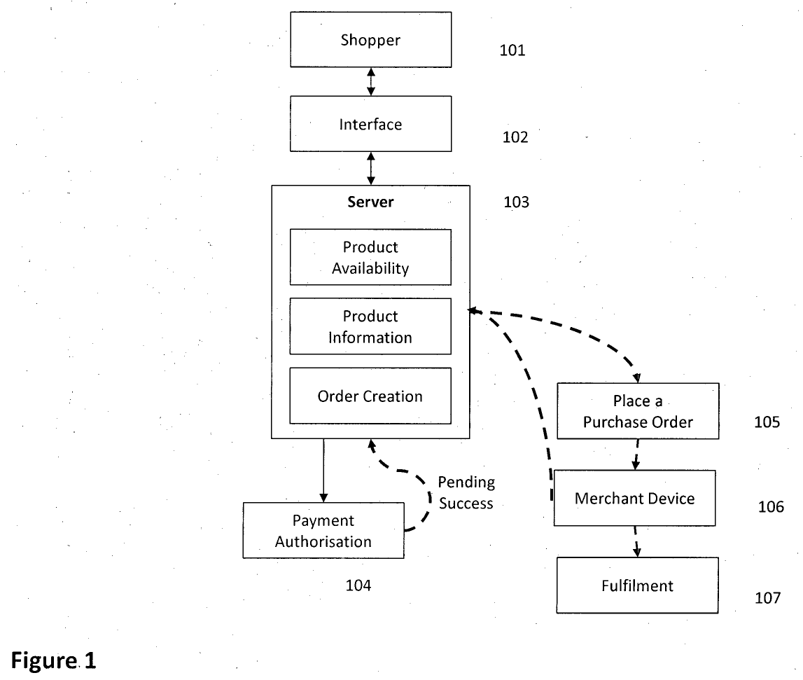

FIG. 2 is a representation of an aspect of the present invention to show that an item can be added into a shopper's personal virtual cart from various media interfaces, and from digital and physical environments. Items added to the personal virtual cart are through a variety of vectors of entry. The personal virtual cart can hold multiple items from multiple merchants, where purchasing may occur at any time.

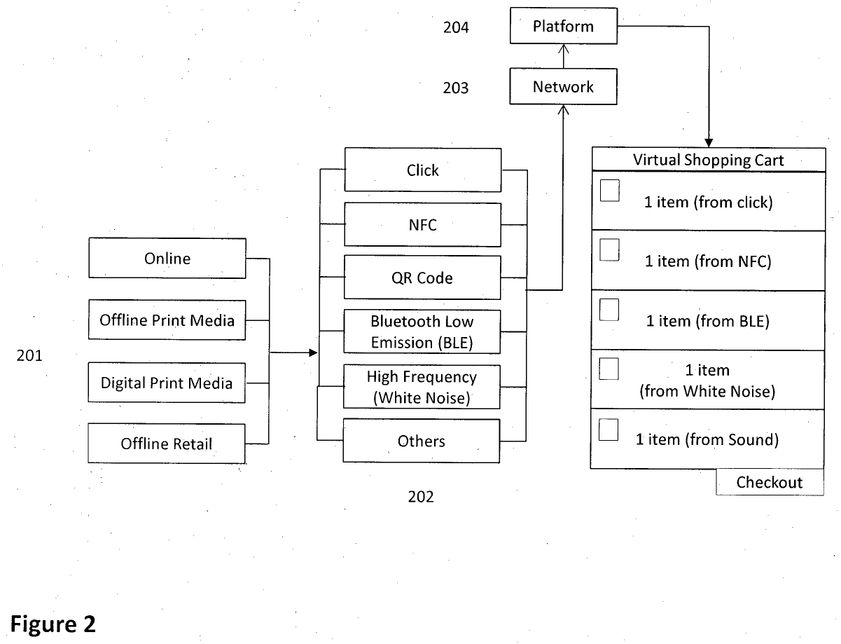

FIG. 3 is an illustration of how a single shopper (in this case Shopper A) can shop at various times and at different digital and physical environments, using various vectors of entry methods to add items to the shopper's personal virtual cart. The shopper will not be restricted to the vectors of entry illustrated in FIG. 3 to add items to the personal virtual cart.

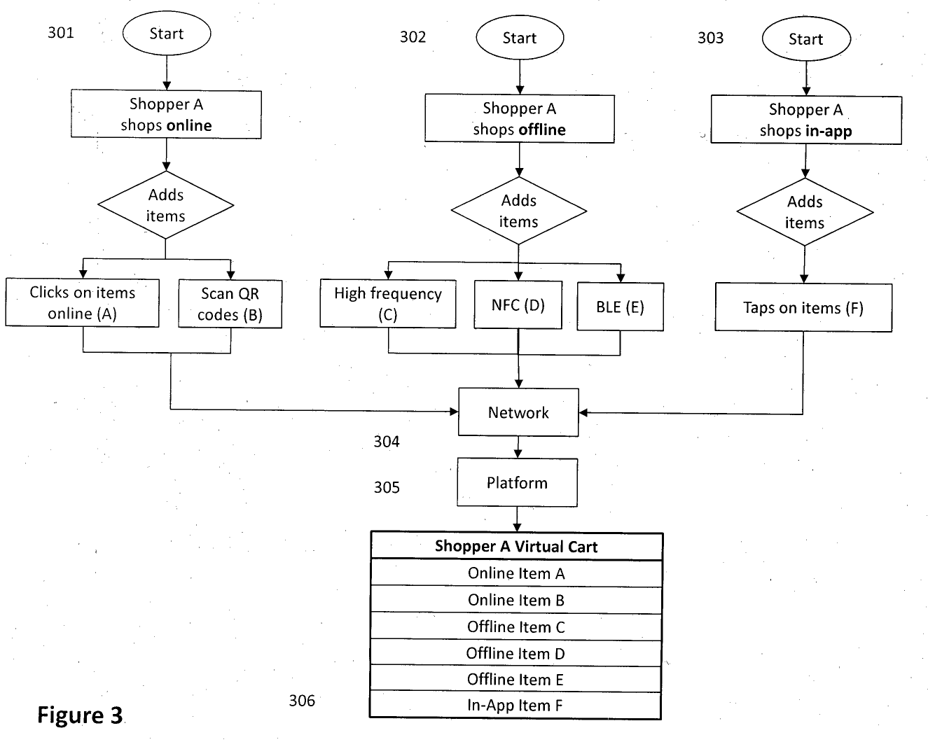

FIG. 4 is an illustration of how the personal virtual cart can be accessed from or displayed on a mobile smart device through an application or a web browser on the mobile smart device.

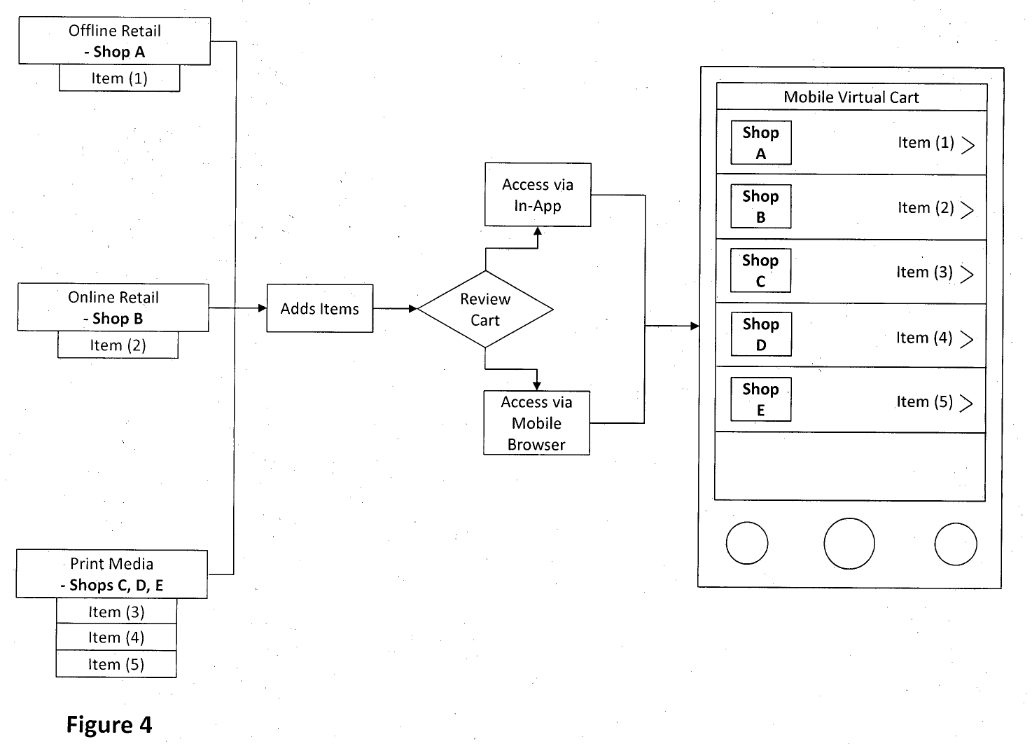

FIG. 5 is an illustration of how a merchant or merchant proxy is able to propose an offer to a shopper with a pre-existing order in the personal virtual cart, which will then update the details of the items in the order and be reflected in the shopper's personal virtual cart.

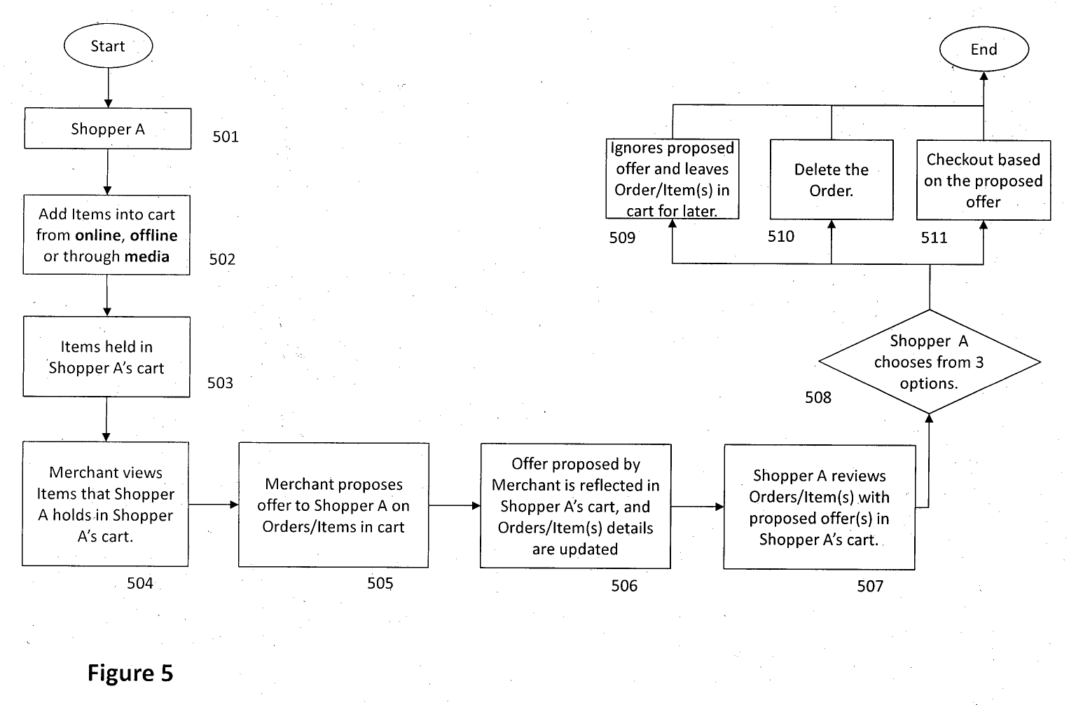

FIG. 6 is a representation of an embodiment of the present invention to show the ability for a merchant or merchant proxy (in this case, Merchant B), to make a offers (in varying forms) in relation to individual items or an order in total, which will then update the details of item(s) or order(s) in a shopper's (in this case, Shopper A's) personal virtual cart.

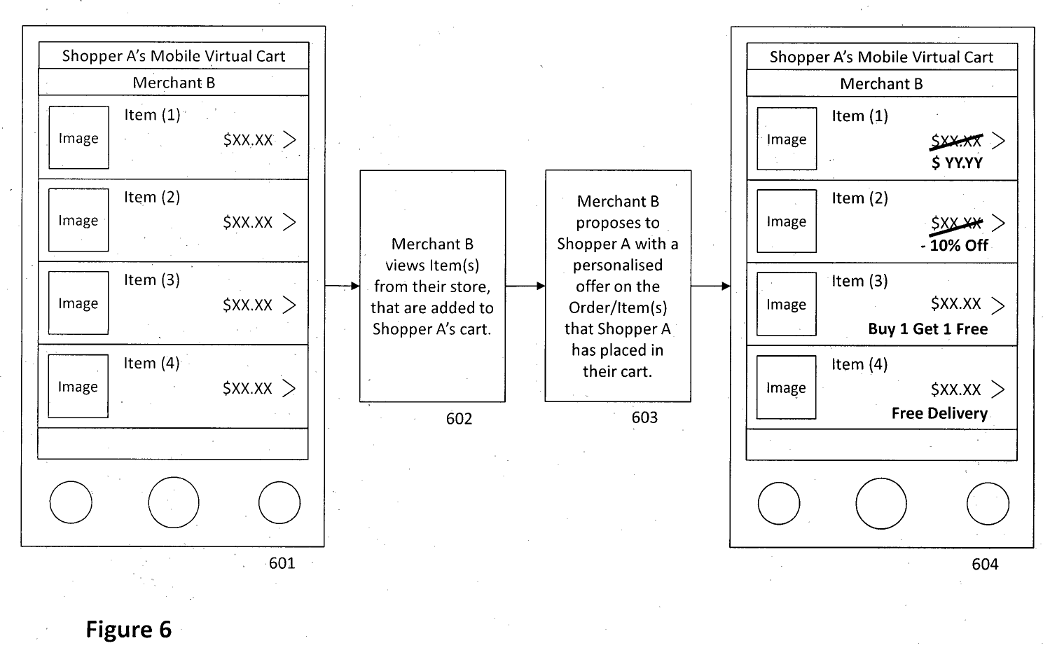

FIG. 7 is a representation of an embodiment of the present invention to illustrate a multi-merchant scenario where a shopper (in this case, Shopper A) has created orders from Merchant B, C and D or merchant proxy/proxies, all of which are still in Shopper A's mobile virtual shopping cart. Merchant B, C and D are able to unilaterally and simultaneously create offers in relation to their respective item(s). Merchant B, C and D's offers as well as the updated details would then be reflected in Shopper A's personal virtual cart. Shopper A can thereafter choose to purchase some or all of the item(s) in the order(s), ignore the offers and leave the orders in the personal virtual cart or delete some or all of the items in the order(s) from the personal virtual cart.

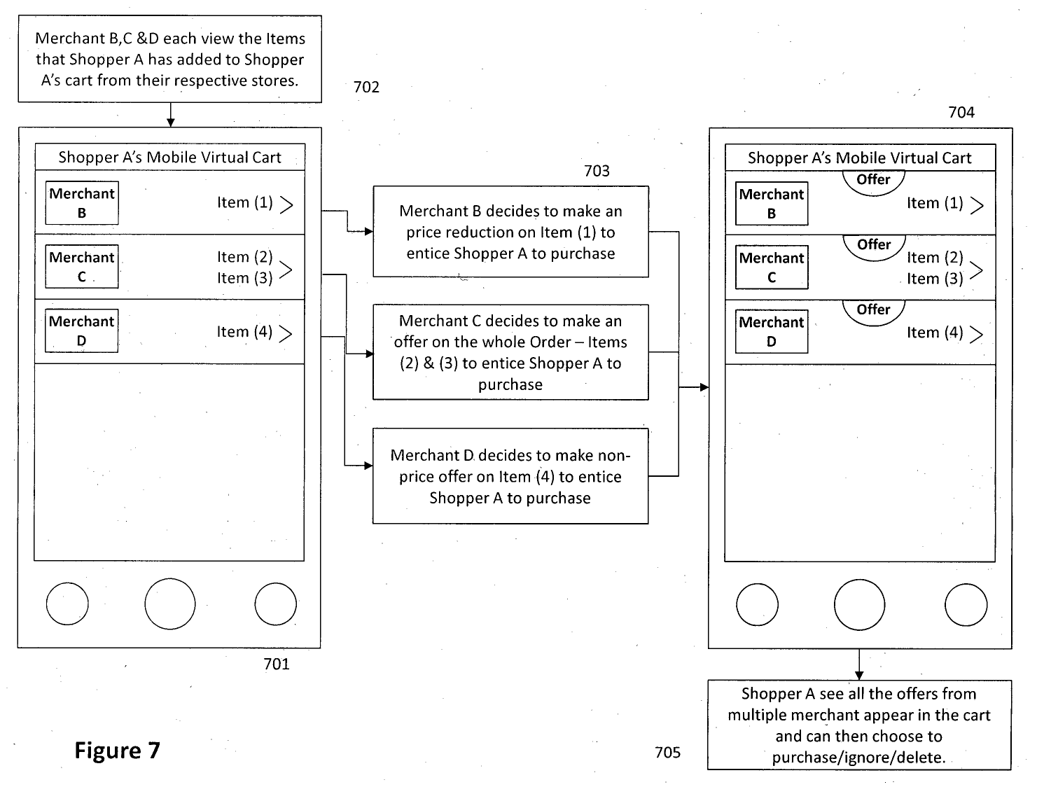

FIG. 8 is a representation of an embodiment of the present invention to show the flow in which a merchant or merchant proxy has the capability to create an offer to shoppers in more ways than one. In this representation, the merchant is able to create an offer for the same item or order for all shoppers who have the particular item in their personal virtual cart or create a personalised offer only for an individual shopper with the item in the personal virtual cart or pre-set an automatic offer which is triggered when particular item(s) is entered or order is created in the shopper's personal virtual cart.

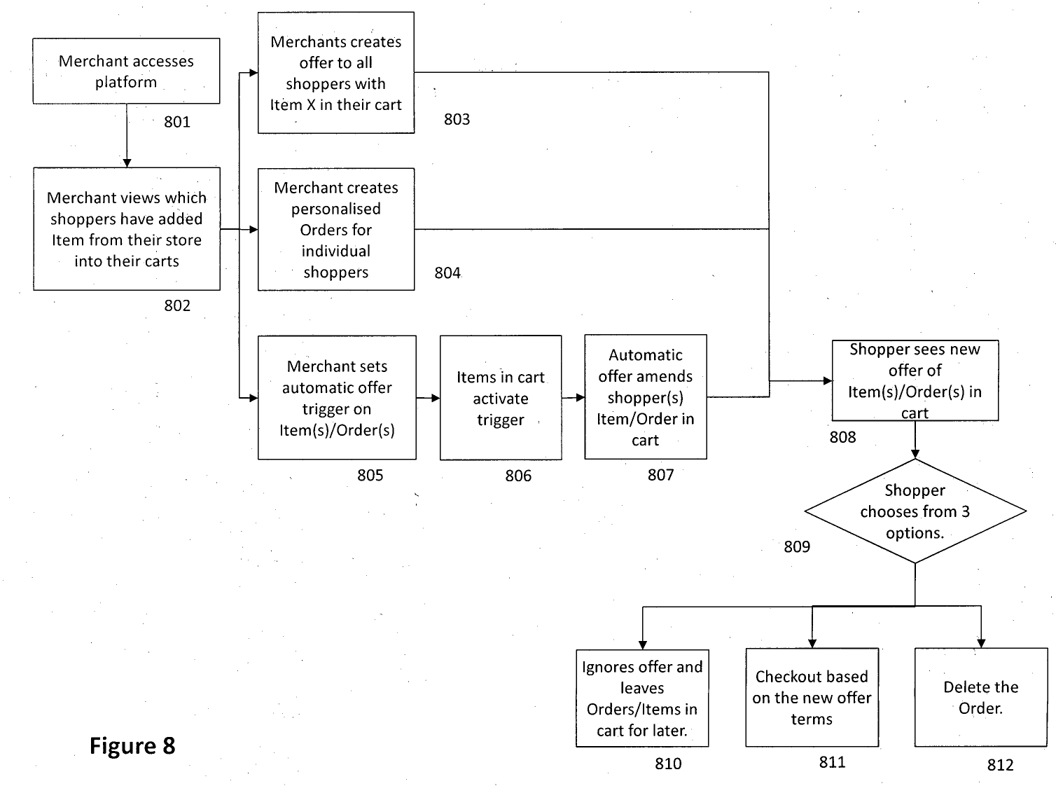

FIG. 9 is a representation of an embodiment of the present invention to show a flow in which a merchant or merchant proxy can access the platform to unilaterally create an order with a special offer to a shopper (in this case, Shopper B), even though unsolicited, and place it in the Shopper B's personal virtual cart. Shopper B can then make the purchase, ignore the offer and leave the order in the personal virtual cart or delete the order from the personal virtual cart.

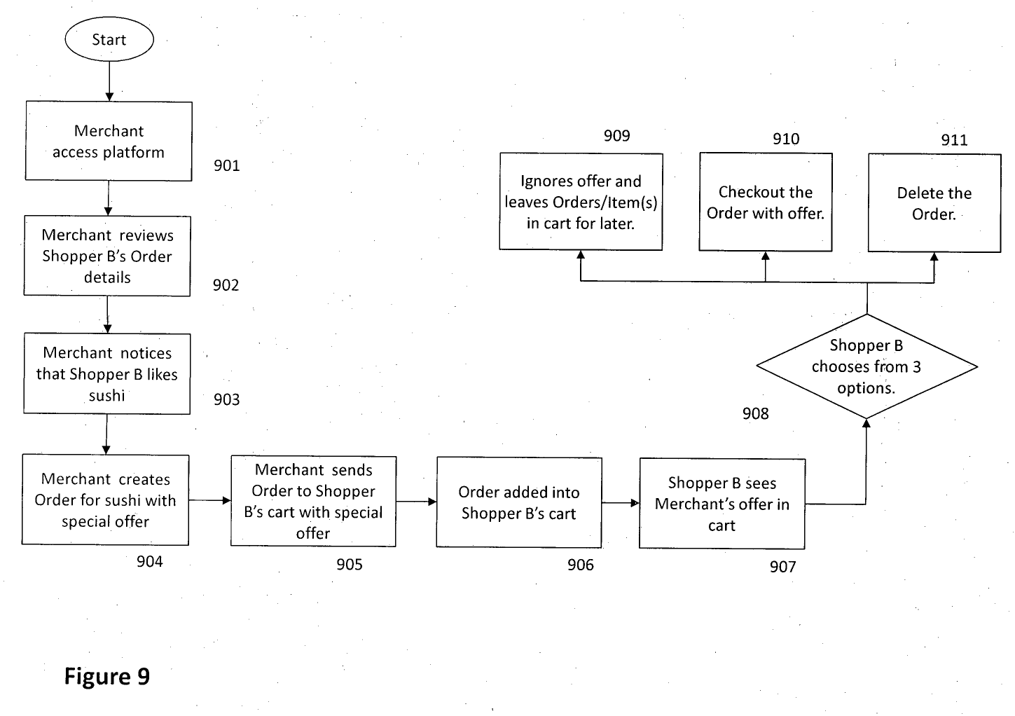

FIG. 10 is a representation of an embodiment of the present invention to show how a merchant or merchant proxy (in this case, Merchant A), who accesses the platform (in this case, a browser or app based merchant management portal), can unilaterally create an order specifically for a shopper (in this case, Shopper B), and the places the order into Shopper B's personal virtual cart as Shopper B's order. Shopper B can thereafter decide to make the purchase, ignore the unsolicited order created by the merchant or merchant proxy or deleted the order from Shopper B's personal virtual cart.

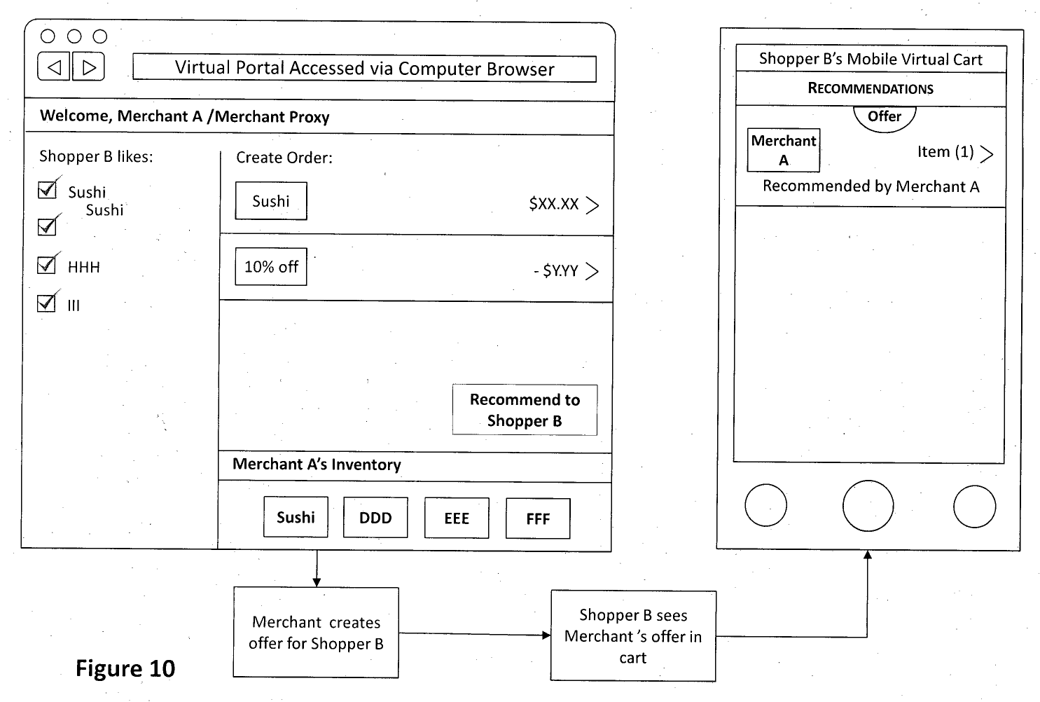

1. A system for electronic commerce, comprising:
a plurality of personal virtual carts associated with devices used for commercial transactions;
computer readable storage platform having computer readable program code embodied;
computer readable program code configured to establish a plurality of personal virtual carts associated with devices used for commercial transactions;
network consists of application programming interfaces (APIs) connecting multiple merchant via single virtual shopping cart;
capabilities for merchants to assess and view order and create offers in relation to the orders, to target or re-target consumers.

2. The system in claim 1, wherein the device may be any smart device which can operate interactively and autonomously, and which may connect to and interface with the platform.

3. The system in claim 2, wherein the platform is further supported by a server to hold all the relevant information.

4. The system in claim 3, wherein the merchant would be able to create offers in relation to orders of the merchant's items and enter the same into the shopper's personal virtual cart.

5. The system in claim 4, wherein the offers created may be generic or specific to individual shoppers.

6. The system in claim 5, wherein the merchant can pre-set the platform so as to generate automatic offers for particular items upon being triggered by the entering of the particular items into personal virtual carts.

7. The system in claim 6, wherein the merchant may create orders and enter the same into the shopper's personal virtual cart even without any pre-existing order of the merchant's items.

8. A computer-implemented method for targeting and re-targeting of shoppers, involving:
using plurality of personal virtual carts through an application or a computer based browser on smart devices connected to a platform via a network;
discovering items of interest while shopping in both online (digital) and offline (physical) environments;
entering of selected items discovered while shopping into personal virtual carts through numerous vectors of data entry;
creating an order in the personal virtual cart and retrieving information of the selected items from the platform to which the smart devices are connected;
notifying merchants when the merchant's items are entered and orders of the merchant's items entered into personal virtual carts are created;
merchants viewing and assessing the platform to retrieve information of the shoppers and/or the orders;
merchants creating offers and entering orders into the personal virtual carts;
accepting or ignoring the offer or deleting the orders entered into the personal virtual cart.

9. The method in claim 8, wherein an order may be created from digital or physical environments, includes but are not limited to websites, Bar Codes, QR Codes, NFC, Bluetooth, Bluetooth Low Energy, Click, White Noise, Sound, Photo identification, In-app selection, marketing and advertising materials in digital or electric or physical print formats.

10. The method in claim 9, wherein the items entered into the personal virtual carts may be from several unrelated and distinct merchants.

11. The method in claim 10, wherein the orders created in the personal virtual carts are actual orders which the shoppers may proceed to purchase directly from the merchants of the items in the orders.

12. The method in claim 11, wherein upon entering of items into a personal virtual cart and creating orders therein, the shopper would be able to retrieve all relevant information of the items as made available by the merchant of the items.

13. The method in claim 12, wherein the orders will remain in the personal virtual cart until the shopper proceeds to purchase the items in the order or deletes the order from the personal virtual cart.

14. A computer program product comprising a computer readable storage medium having computer readable program code embodied therewith, the computer readable program code comprising:
computer readable program code configured to establish a plurality of personal virtual carts associated with shopping devices used by shoppers, wherein the devices are connected by a network;
computer readable program code configured to enable merchants to assess and view orders and create offers in relation to the orders, to target or re-target shoppers.

15. A computer program product of claim 14, wherein the personal virtual cart may be presented within an application or through a web browser on any smart device which can operate interactively and autonomously, and which may connect to and interface with the proprietary platform.
